(19) United States
(12) Patent Application Publication
(10) Pub. No.: US 2008/0291474 A1
(43) Pub. Date: Nov. 27, 2008

(54) PRINT SETTING APPARATUS, PRINT SETTING PROGRAM, PRINT SETTING METHOD

(75) Inventors: Naoki Hoshino, Saitama-ken (JP); Yuko Kimoto, Kanagawa-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/753,609

(22) Filed: May 25, 2007

(51) Int. Cl. G06F 15/00

(52) U.S. Cl. 358/1.9

(57) ABSTRACT

A print setting apparatus that carries out print setting for an image processing apparatus, includes: a paper display unit configured to display predetermined paper information related to a paper that can be used, as a list; a printed matter display unit configured to display a printed matter, as a page list; a selected paper information acquiring unit configured to acquire selected paper information showing which paper information is selected, of the paper information displayed as a list; an insertion position information acquiring unit configured to acquire insertion position information showing which page position a paper should be inserted to, of the pages displayed as a list; and an insertion state reflecting unit configured to reflect the selected paper information in the page list displayed by the printed matter display unit, in a form that the selected paper information is inserted in the insertion position information.

### BACKGROUND OF THE INVENTION

1. Field of the Invention

The present invention relates to a print setting apparatus, a print setting program and a print setting method for setting the print state of printed matter, and particularly to displaying of the print state.

2. Description of the Related Art

Traditionally, in the case where a chaptered original (printed matter) is prepared, a method of inserting an insertion paper such as a color paper at changeover parts of the chapters and thereby emphasizing the changeover of each chapter is generally employed. Here, in the case where double-side printing or layout printing such as printing two pages on one sheet of paper is to be carried out, the user must consider the influence of the insertion of insertion papers on page number (for example, whether no printing is made on the insertion papers, whether page numbers are shifted by the insertion of the insertion papers, etc.), and the user must set page numbers while paying attention to the page numbers close to the inserted pages.

Also, currently it is common that an original is prepared on a document preparation application in a personal computer. For the original prepared in this manner, print setting (setting of insertion papers) is made on a print setting screen of a printer driver in the personal computer, and after that, the original is printed by a printing machine. In the case where the preparation of the original and the setting of insertion papers are carried out on the personal computer in this manner, the user wants to set insertion papers while confirming the printed matter displayed by a preview function of the document preparation application. However, when the user turns the print setting screen of the printer driver into the active state, the preview display of the document preparation application usually turns non-active (the preview shifts behind the setting screen of the printer driver and cannot be operated). Therefore, the user must constantly switch the display between the print setting screen of the printer driver and the document preparation application. Alternatively, the user must print out the original in advance and keep it at hand, then display the print setting screen of the printer driver, and make print setting while confirming the original that is at hand, or the user must take notes of the page numbers of the original in advance and carry out print setting while managing the page numbers by using the notes.

To assist the setting of insertion papers as described above, a printer driver that displays setting contents of page numbers by icons or preview on the print setting screen is known.

However, the display by icons or preview on the print setting screen of the traditional printer driver is an abstracted display. Therefore, practically, the user finds it difficult to grasp how insertion papers are set. Particularly, in the case where plural insertion papers are set, it is difficult to grasp how the insertion papers affect each other. Therefore, in order to confirm the result of print, the user must print a part of the original and then print a required number of copies after confirming the content.

Also, a printer driver is known that displays papers of which paper feed cassette (or manual insertion tray) should be used, on the print setting screen, when the user carries out printing. However, the traditional printer driver displays the identifier allocated in advance to the paper feed cassette, only by text, or it displays information about the paper feed cassette to be used, only by abstracted symbol, though it displays an image of the printing machine. Therefore, the user finds it difficult to grasp where in the printing machine body the paper feed cassette is stored, and finds it difficult to intuitively grasp the type of insertion papers to be used and the position information of the paper feed cassette. Moreover, in the traditional printer driver that displays an image of the printing machine on the print setting screen, if the paper feed setting is automatic setting, a display notifying the user of automatic setting is not shown on the image of the printing machine and therefore the user cannot intuitively understand that it is automatic setting.

### SUMMARY OF THE INVENTION

It is an object of an embodiment of the invention to provide a print setting apparatus, a print setting program and a print setting method having a user interface that enables the user to intuitively grasp the state of an insertion paper when the user sets the insertion paper.

To solve the above problem, a print setting apparatus according to an aspect of the invention is a print setting apparatus that carries out print setting for an image processing apparatus. The print setting apparatus includes: a paper display unit configured to display predetermined paper information related to a paper that can be used in the image processing apparatus, as a list; a printed matter display unit configured to display a printed matter, which is a print target in the image processing apparatus, as a page list; a selected paper information acquiring unit configured to acquire selected paper information showing which paper information is selected, of the paper information displayed as a list by the paper display unit; an insertion position information acquiring unit configured to acquire insertion position information showing which page position a paper should be inserted to, in the page list displayed by the printed matter display unit; and an insertion state reflecting unit configured to reflect the selected paper information acquired by the selected paper information acquiring unit, in the page list displayed by the printed matter display unit, in a form that the selected paper information is inserted in the insertion position information acquired by the insertion position information acquiring unit.

Also, a print setting program according to an aspect of the invention is a print setting program that causes a computer to execute print setting for an image processing apparatus. The program includes the steps of: displaying predetermined paper information related to a paper that can be used in the image processing apparatus, as a list; displaying a printed matter, which is a print target in the image processing apparatus, as a page list; acquiring selected paper information showing which paper information is selected, of the paper information displayed as a list in the step of displaying paper information; acquiring insertion position information showing which page position a paper should be inserted to, in the page list displayed in the step of displaying a printed matter; and reflecting the selected paper information acquired in the step of acquiring selected paper information, in the page list displayed in the step of displaying a printed patter, in a form that the selected paper information is inserted in the insertion position information acquired in the step of acquiring insertion position information.

Moreover, a print setting method according to an aspect of the invention is a print setting method for executing print setting for an image processing apparatus. The method includes the steps of: displaying predetermined paper information related to a paper that can be used in the image processing apparatus, as a list; displaying a printed matter, which is a print target in the image processing apparatus, as a page list; acquiring selected paper information showing which paper information is selected, of the paper information displayed as a list in the step of displaying paper information; acquiring insertion position information showing which page position a paper should be inserted to, in the page list displayed in the step of displaying a printed matter; and reflecting the selected paper information acquired in the step of acquiring selected paper information, in the page list displayed in the step of displaying a printed patter, in a form that the selected paper information is inserted in the insertion position information acquired in the step of acquiring insertion position information.

### DESCRIPTION OF THE DRAWINGS

FIG. 1 is a configuration view for explaining a network configuration including a print setting apparatus according to the embodiment.

FIG. 2 is a perspective view of appearance of an image processing apparatus according to the embodiment.

FIG. 3 is a functional block diagram for explaining the print setting apparatus according to the embodiment.

FIG. 4 is a view for explaining the arrangement of a sensor according the embodiment.

FIG. 5 is a view for explaining a processing flow in the print setting apparatus according to the embodiment.

FIG. 6 is a view for explaining a main menu screen of a print setting screen in the print setting apparatus according to the embodiment.

FIG. 7 is a view for explaining a paper list display and a page list display on the print setting screen in the print setting apparatus according to the embodiment.

FIG. 8 is a view for explaining a paper change operation on the print setting screen in the print setting apparatus according to the embodiment.

FIG. 9 is a view for explaining an operation for inserting an insertion paper on the print setting screen in the print setting apparatus according to the embodiment.

FIG. 10 is a view showing an enlarged graphical image of the image processing apparatus on the main menu screen shown in FIG. 6 (setting for plural papers).

FIG. 11 is a view showing an enlarged graphical image of the image processing apparatus on the main menu screen shown in FIG. 6 (automatic paper feed setting).

FIG. 12 is a view showing a preview display in a page turning format by a print preview unit according to the embodiment.

### DESCRIPTION OF THE EMBODIMENTS

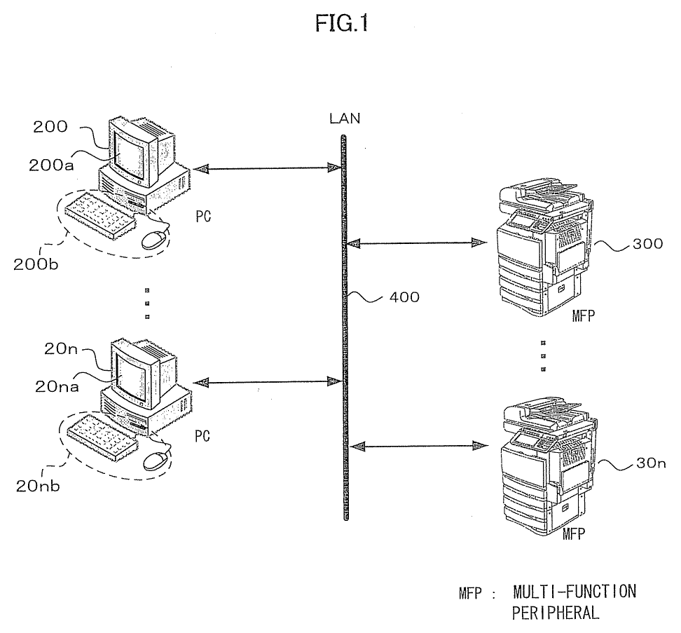

Hereinafter, an embodiment of the invention will be described with reference to the drawings. FIG. 1 is a configuration view showing an exemplary network configuration including a print setting apparatus 1 according to this embodiment. In this embodiment, a personal computer 200 (PC) and a print processing apparatus 300 are connected to each other via a LAN 400 (local area network). Also, the personal computer 200 has a monitor 200a that outputs a screen displayed by the print setting apparatus 1, and an input device 200b that accepts an input as an instruction from a user to the print setting apparatus 1. Also, plural personal computers 200 and image processing apparatuses 300 may be installed, such as personal computers 20n and print processing apparatuses 30n as shown in FIG. 1. It is also assumed that a document preparation application to prepare an original (printed matter) has been introduced into the personal computer 200.

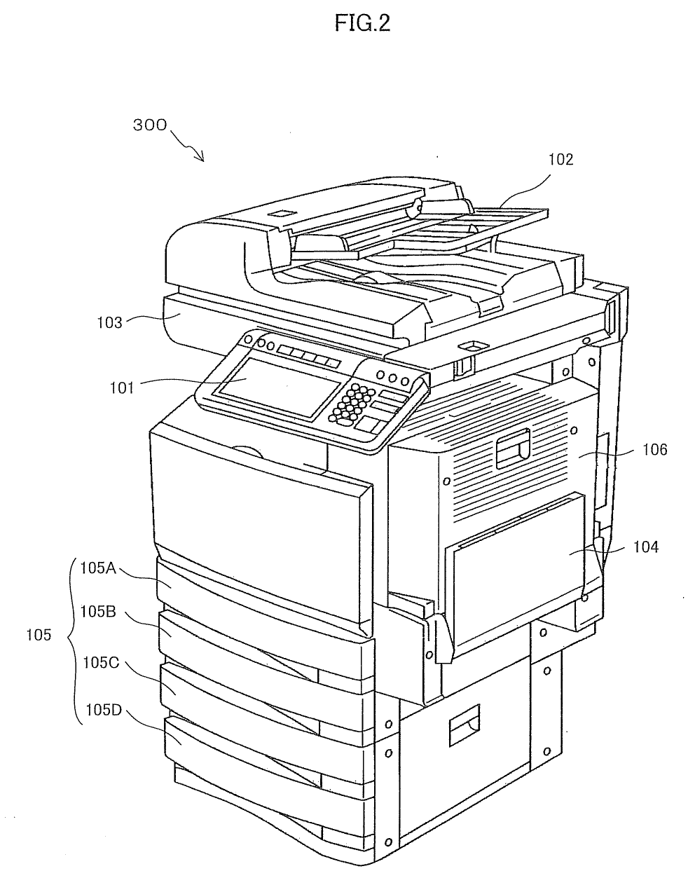

FIG. 2 is a perspective view of appearance for explaining the outline of the image processing apparatus 300 according to this embodiment. The image processing apparatus 300 in this embodiment is a multi-function peripheral having various functions such as printer function, scanner function and copy function by itself.

The image processing apparatus 300 has an interface screen 101, an ADF (automatic document feeder) 102, an image reading unit 103, a manual paper feed unit 104, paper feed cassettes (105A, 105B, 105C and 105D) (hereinafter, the paper feed cassettes (105A to 105D) are referred to as “paper feed cassette unit 105”, when necessary), and an image forming unit 106.

Hereinafter, a printer output processing operation will be briefly described as an example of processing in the image processing apparatus 300 according to this embodiment. The image processing apparatus 300 receives original data prepared by the user with the document preparation application in the personal computer 200, from the personal computer 200 via the LAN 400. In order to print the original data thus received, the paper feed cassette unit 105 or the manual paper feed unit 104 provided in the image processing apparatus 300 carries out a paper feed operation. The supplied paper is carried to the image forming unit 106 and image forming processing is carried out in accordance with the received original data.

Also, the interface screen 101 is formed by, for example, a touch panel display, and also serves as an operation input unit that accepts the user's operation input in accordance with the display content on the interface screen 101.

The ADF 102 and the image reading unit 103 are used when the image processing apparatus 300 carries out copy processing or scanner processing. The original set on the ADF 102 is automatically carried to the position for original reading by the image reading unit (image processing unit) 103, and an image of the carried original is read by the image reading unit 103.

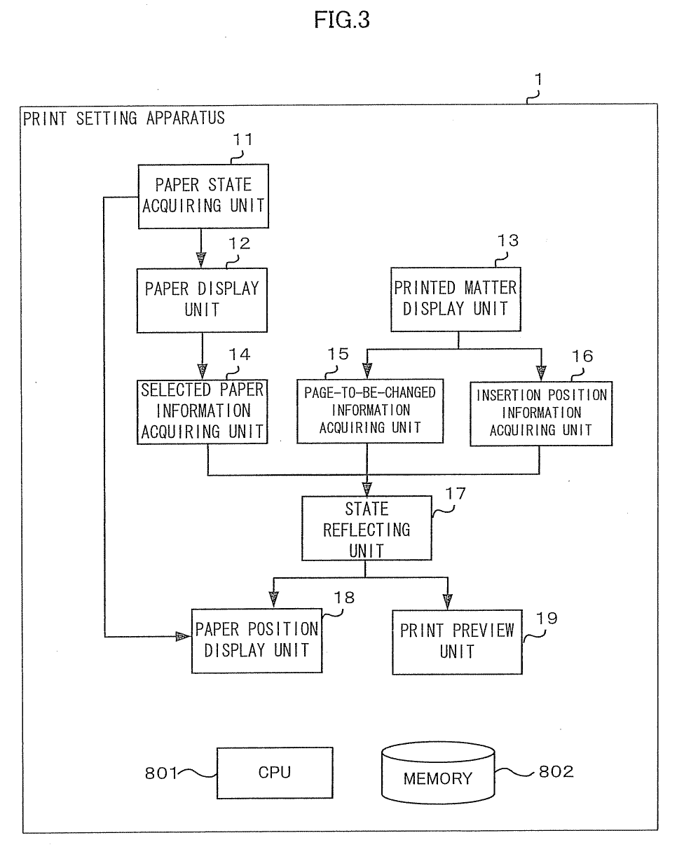

Next, the print setting apparatus 1 according to this embodiment will be described. FIG. 3 is a functional block diagram of the print setting apparatus 1.

The print setting apparatus 1 according to this embodiment has a paper statue acquiring unit 11 (paper state information acquiring unit), a paper display unit 12, a printed matter display unit 13, a selected paper information acquiring unit 14, a page-to-be-changed information acquiring unit 15, an insertion position information acquiring unit 16, a state reflecting unit 17 (insertion state reflecting unit and change state reflecting unit), a paper position display unit 18, a print preview unit 19, a CPU 801, and a memory 802. In this embodiment, it is assumed that the print setting apparatus 1 is mounted on the personal computer 200.

Next, each functional block will be described. The paper state acquiring unit 11 acquires paper information, which is information about the size of paper, the color of paper and the direction of paper (type of paper), and cassette information, which is the identifier of the paper feed cassettes (105A to 105D) or the manual paper feed unit 104 (“manual”, “first cassette”, “second cassette” and so on), and also acquires information (storage position information) about the position of the paper feed cassettes (105A to 105D) and the manual paper feed unit 104 in which papers have been set, in the image processing apparatus 300. The paper display unit 12 displays a list of the above paper information and cassette information in the form of characters and image data of the papers. Also, the printed matter display unit 13 displays a list of the original of the print target by page.

The selected paper information acquiring unit 14 acquires information of a paper selected as an insertion paper (or change paper) from the paper display unit 12. The page-to-be-changed information acquiring unit 15 acquires page-to-be-changed information indicating which page of print paper should be changed, from the page list displayed by the printed matter display unit 13. The insertion position information acquiring unit 16 acquires insertion position information indicating which page position a paper should be inserted to, from the page list displayed by the printed matter display unit 13.

The state reflecting unit 17 constantly reflects the print state in the printed matter display unit 13 every time the print state is changed by page insertion (or paper change).

The paper position display unit 18 displays the above storage position information, the paper information and the cassette information together with a graphical image of the image processing apparatus 300. The print preview unit 19 displays the print state in a page turning format.

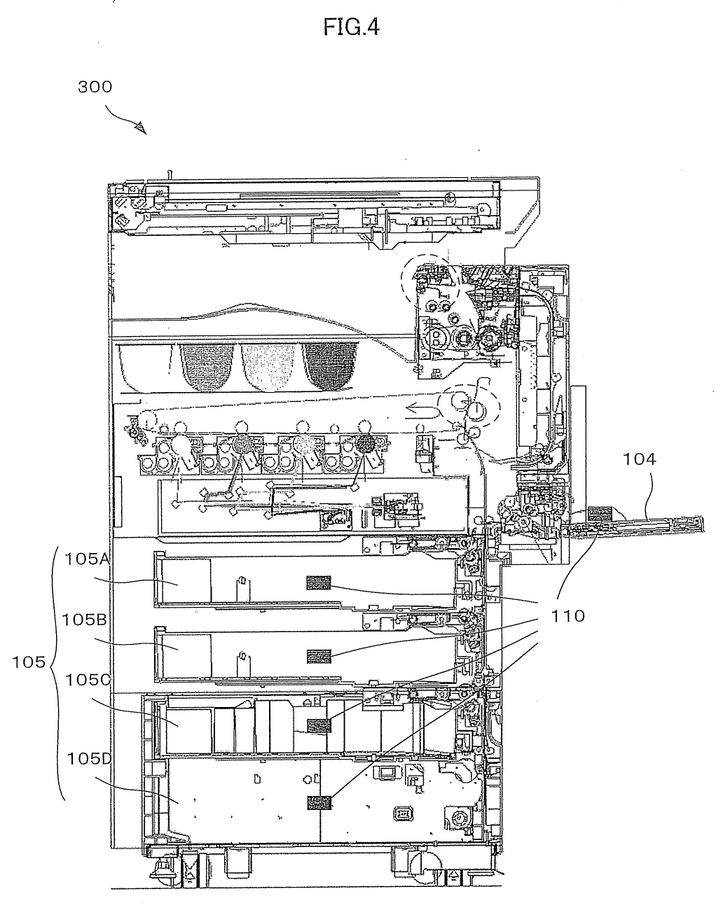

Also, the image processing apparatus 300 has sensors 110, which are medium sensors and measuring sensors that detect the above paper information displayed by the paper display unit 12 and the paper position display unit 18 from the actual paper. The sensors 110 are mounted within the manual paper feed unit 104 and the paper feed cassette unit 105, as shown in the sectional view of the image processing apparatus 300 of FIG. 4.

In this embodiment, the above paper information is described as the color of paper detected by the medium sensor and the paper size and the direction of paper detected by the measuring sensor. However, it may be any information that can be detected by the sensors mounted in the manual paper feed unit 104 and the paper feed cassette unit 105. Also, it is desired that sensors that can detect the paper quality such as plain paper and ink-jet paper, the quantity of remaining papers (the number of remaining papers), and the print state in the case where back no-print papers that have been used only on their one side are used, should be mounted in the manual paper feed unit 104 and the paper feed cassette unit 105. In this case the sensors 110 detect the information of the paper quality, the quantity of remaining papers and the print state, and the paper display unit 12 and the paper position display unit 18 display the information of the paper quality, the quantity of remaining papers and the print state.

Meanwhile, the CPU 801 provided in the print setting apparatus 1 is responsible for carrying out various kinds of processing in the print setting apparatus 1 and is also responsible for realizing various functions by executing programs stored in the memory 802 provided in the print setting apparatus 1. The memory 802 is formed by, for example, a ROM or RAM, and is responsible for storing various kinds of information and programs to be used in the print setting apparatus 1.

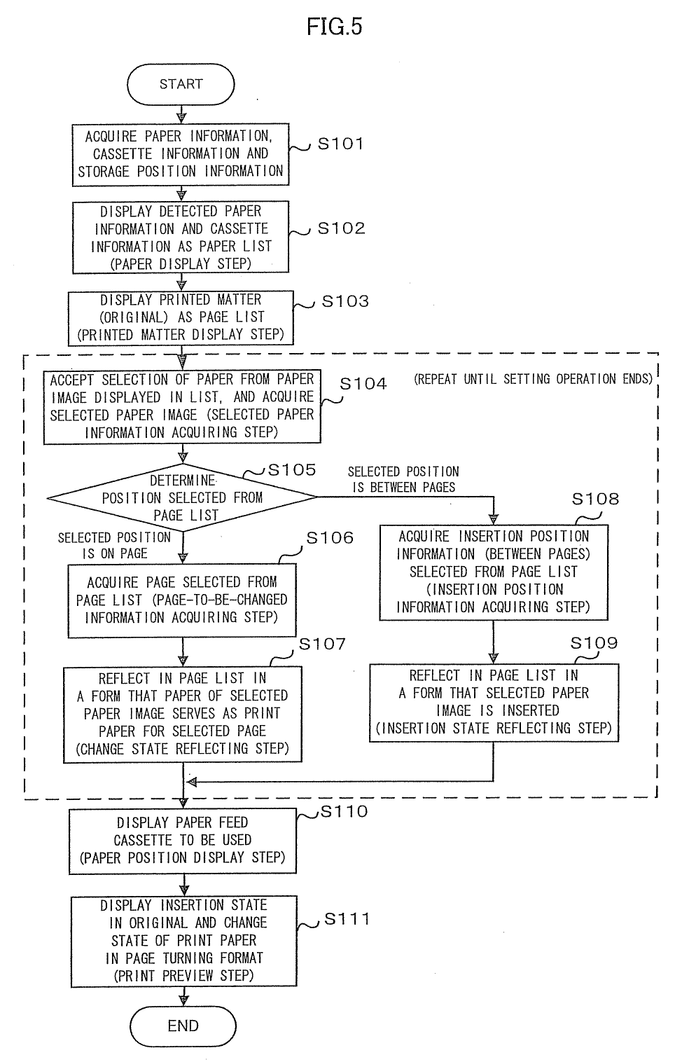

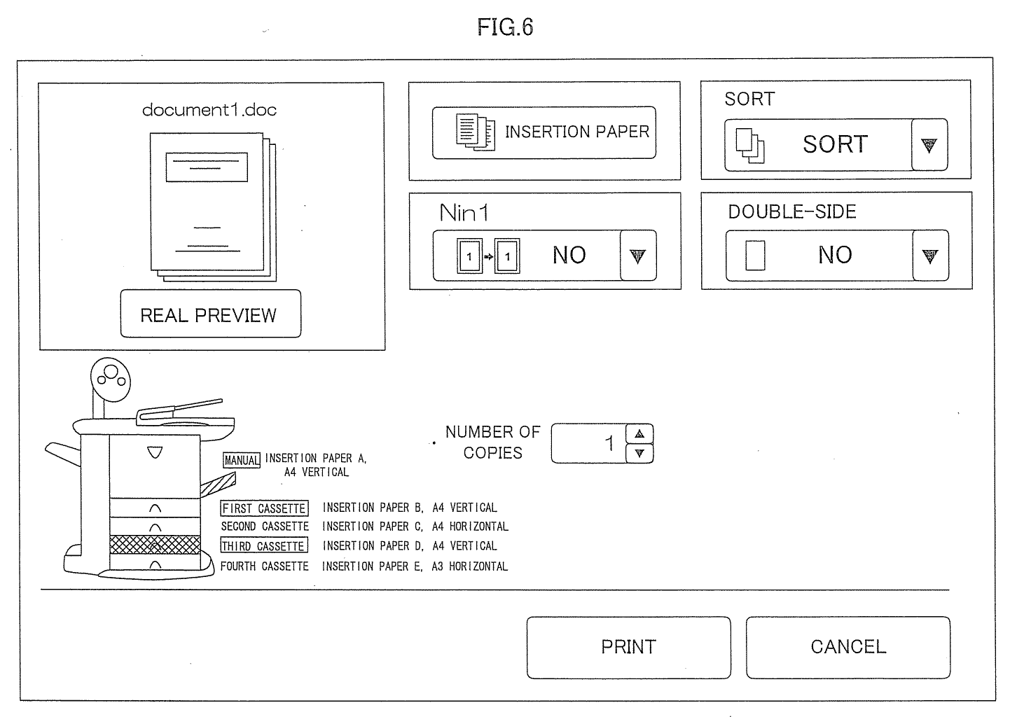

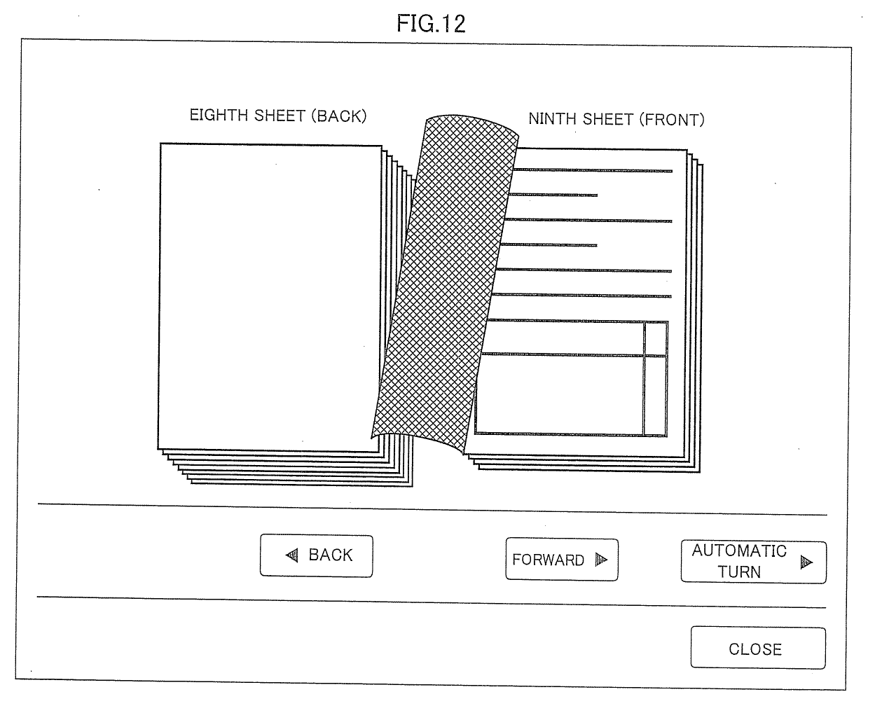

Next, the processing in the print setting apparatus 1 according to this embodiment will be described. A flow of processing in the print setting apparatus 1 is shown in the flowchart of FIG. 5, and exemplary screen images displayed on the monitor 200a are shown in FIG. 6 to FIG. 12. Hereinafter, description will be made with reference to the flowchart and the screen images.

First, a main menu screen for carrying out various setting in the print setting apparatus 1 according to this embodiment is shown in FIG. 6. As an “Insertion Paper” button on the main menu screen is pressed, the processing of the flowchart shown in FIG. 5 is started. On this main menu screen, setting items that are generally set at the time of printing, such as the number of copies to be printed, paper layout setting (Nin1), double-side print setting, and sort setting, are prepared in addition to the “Insertion Paper” button. Also, an image of the image processing apparatus (bottom left part in FIG. 6), which will be described later, and a “Real Preview” button are prepared on the main menu screen.

On the main menu screen of FIG. 6, when the “Insertion Paper” button is pressed, the paper state acquiring unit 11 acquires paper information, cassette information and storage position information from the image processing apparatus 300 (step S101).

In the image processing apparatus 300, the correspondence between “sensor that detects paper information”, “cassette information” and “storage position information” has been saved in advance. The image processing apparatus 300 first detects the paper information and the cassette information by the sensor provided in the paper feed cassette unit 105 or the manual paper feed unit 104. After that, the image processing apparatus 300 detects the cassette information and the storage position information on the basis of the sensor that has detected the paper information and the above correspondence. The paper state acquiring unit 11 acquires these items of information.

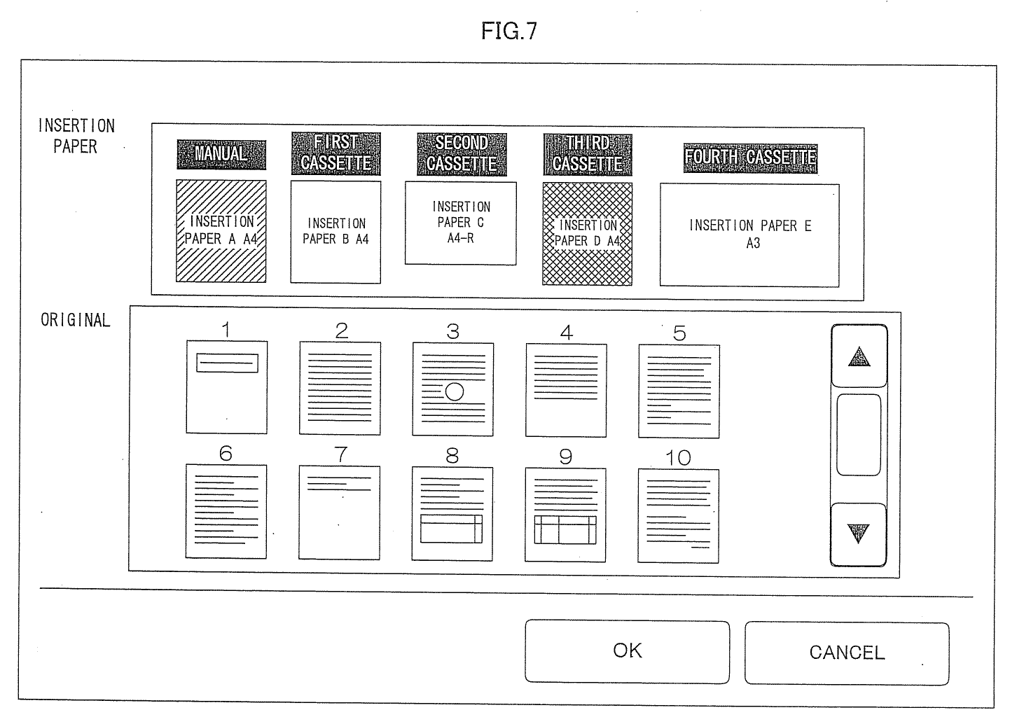

The paper display unit 12 displays a list of the paper information and the cassette information acquired by the paper state acquiring unit 11, in the form of paper image and characters (step S102). An example of the list displayed by the paper display unit 12 is shown in the section of “Insertion Paper” in the top part of FIG. 7. The paper display unit 12 displays the paper size of the paper information (for example, A4 size, A3 size and so on in Japan) and the cassette information (“Manual”, “First Cassette”, “Second Cassette” and so on) in the form of characters together with the identifier of the paper (“Insertion Paper A”, “Insertion Paper B” and soon). The paper display unit 12 also shows the color of paper and the direction of paper (vertical or horizontal) in the form of image data of the paper.

In this embodiment, as insertion papers A, A4 vertical-size green papers (shaded by slant lines in FIG. 7) are set in the manual paper feed unit 104 (manual), and as insertion papers B, A4 vertical-size white papers are set in the paper feed cassette 105A (first cassette). Also, as insertion papers C, A4 horizontal-size white papers are set in the paper feed cassette 105B (second cassette), and as insertion papers D, A4 vertical-size blue papers (crosshatched in FIG. 7) are set in the paper feed cassette 105C (third cassette). As insertion papers E, A3 horizontal-size white papers are set in the paper feed cassette 105D (fourth cassette).

The printed matter display unit 13 displays the content of the original, which is a print target, in the form of page list (step S103). An example of the page list displayed by the printed matter display unit 13 is shown in the section of “Original” in the bottom part of FIG. 7. The printed matter display unit 13 displays the content of the original, which is a print target, together with page numbers.

As a paper image (insertion paper) to be used is selected from the paper list displayed by the paper display unit 12 by the user's drag operation of the mouse of the input device 200b, the selected paper information acquiring unit 14 acquires the selected paper (selected paper information) (step S104).

Next, the printed matter display unit 13 determines at which position in the displayed page list, the selected paper selected by the drag operation should be dropped (step S105).

In the case where the position where the drop operation is made is on a page in the page list displayed by the printed matter display unit 13, the page-to-be-changed information acquiring unit 15 acquires the page selected by the drop operation as a page where paper change is carried out (page-to-be-changed information) (step S106).

After that, the state reflecting unit 17 makes a reflection in the page list of the printed matter display unit 13, in the form that the selected paper acquired by the selected paper information acquiring unit 14 serves as a print paper for the page acquired by the page-to-be-changed information acquiring unit 15 (step S107).

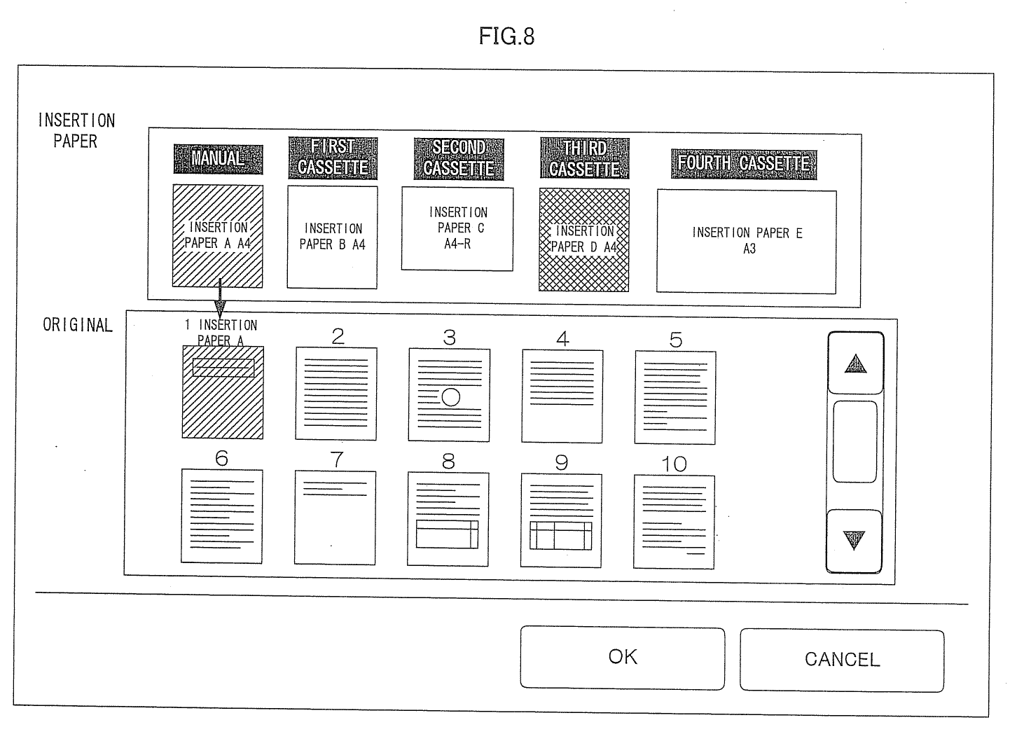

To facilitate understanding of the processing of the above steps S104 to S107, an exemplary paper change operation is shown in FIG. 8. For example, in the case where the insertion paper A is selected (dragged) by the user in the paper list (top of FIG. 8) displayed by the paper display unit 12 and the insertion paper A is dropped onto the page of page number 1 in the page list (bottom of FIG. 8) displayed by the printed matter display unit 13, the page number 1 is displayed in the state where the print paper is changed to a paper of the insertion paper A (A4 vertical-size green paper) with the print content left unchanged.

If the state reflecting unit 17 shows which paper is to be used together with the page number by characters (“1 Insertion Paper A” in FIG. 8) with respect to the changed page, the content of the paper setting can be grasped more intuitively.

Back to the flowchart of FIG. 5, in the case where the position where drop operation is made is between pages in the page list displayed by the printed matter display unit 13 in the above step S105, the insertion position information acquiring unit 16 acquires the position between the pages selected by the drop operation from the page list displayed by the printed matter display unit 13, as insertion position information (step S108).

After that, the state reflecting unit 17 makes a reflection in the page list of the printed matter display unit 13, in a form that the selected paper acquired by the selected paper information acquiring unit 14 is inserted between the pages acquired by the insertion position information acquiring unit 16 (step S109).

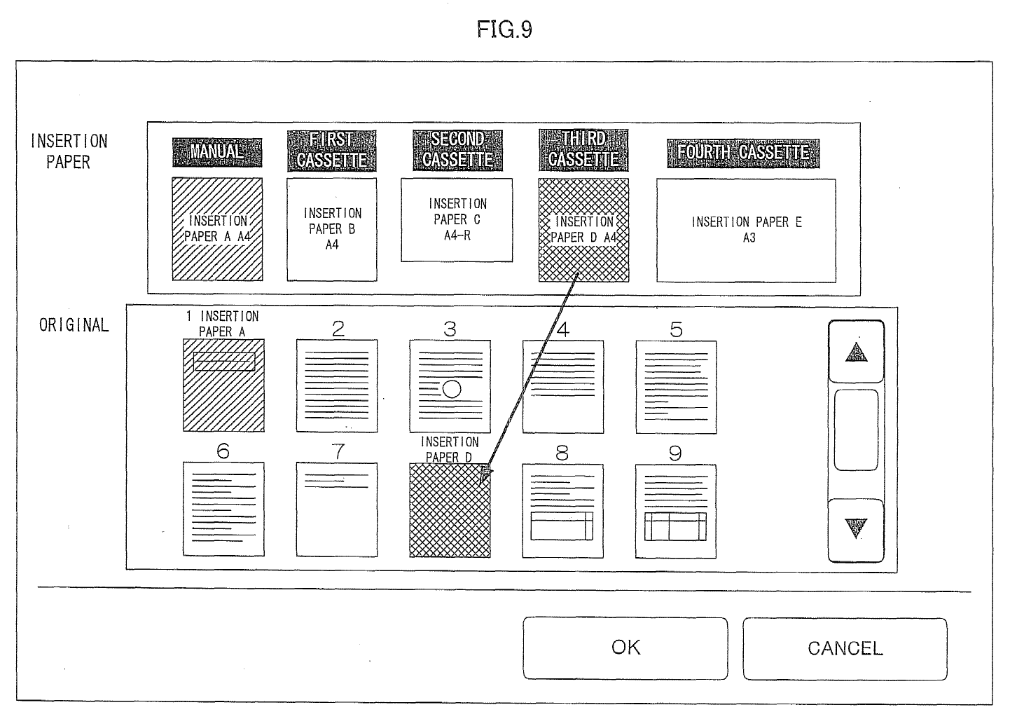

To facilitate understanding of the processing of the above steps S104 to S109, an exemplary screen image is shown in FIG. 9. For example, in the case where the insertion paper D is selected (dragged) by the user in the paper list (top of FIG. 9) displayed by the paper display unit 12 and the insertion paper D is dropped between page number 7 and page number 8 in the page list (bottom of FIG. 9) displayed by the printed matter display unit 13, the insertion paper D (A4 vertical-size blue paper) is displayed in the state of being inserted between the page number 7 and the page number 8.

In the case where the selected paper is dropped near the left side of the page number 1 in the page list displayed by the printed matter display unit 13, the dragged selected paper serves as the front cover. In the case where the selected paper is dropped near the right side of the last page, the dragged selected paper serves as the back cover of the printed matter.

Meanwhile, if the inserted selected paper is not included in page numbers of the printed matter (not included as a paper to be counted for page number), for example, a shift in page number that would be caused in the case of double-side print or layout print of printing two pages on one sheet of paper, or misalignment such as an unintended print on the color paper selected as the insertion paper, can be avoided.

When the above paper setting operation (processing of steps S104 to S107 or processing of steps S104 to S109) is carried out by the user and a series of paper setting operations is completed, the state reflecting unit 17 decides the paper setting content as the “OK” button in FIG. 9 is pressed by the user, and the display on the monitor 200a returns to the main menu screen of FIG. 6.

To allow the user to intuitively grasp papers of which of the paper feed cassettes (105A to 105D) and the manual paper feed unit 104 in the image processing apparatus 300 are used with respect to the original for which the paper setting has been done as described above, the paper position display unit 18 displays the paper information, cassette information and storage position information in the form of characters or color information of the paper, association with a graphic image of the image processing apparatus 300 in the bottom left part of the main menu screen of FIG. 6 (step S110). Moreover, the paper position display unit 18 highlights the paper to be used at the time of printing.

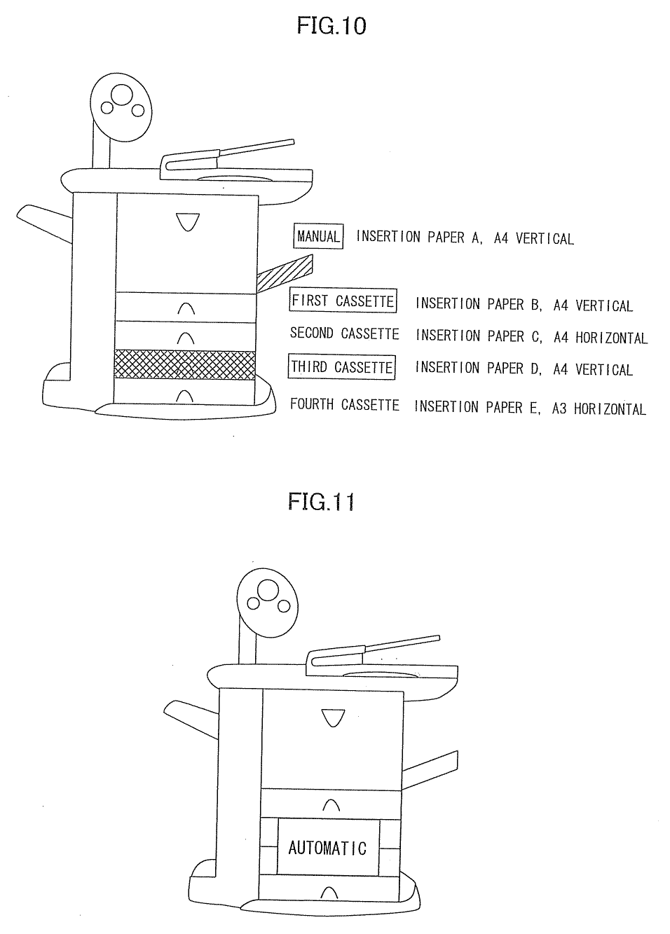

An enlarged view of the graphic image of the image processing apparatus 300 displayed on the main menu screen of FIG. 6 is shown in FIG. 10. The paper position display unit 18 displays the cassette information and the paper size and direction of paper of the paper information in the form of paper identifier and characters associated with the graphic image of the image processing apparatus 300 as shown in FIG. 10, and also displays the storage position information by coloring the corresponding positions in the graphic image of the image processing apparatus 300 (the manual paper feed unit 104 and the paper feed cassette unit 105 in the graphic image of the image processing apparatus 300) in the color of paper of the paper information. For example, in the case where green papers are set in the manual paper feed unit 104, the paper position display unit 18 displays the cassette information and the like by characters, and colors the position of the manual paper feed unit 104 in green (shaded by slant lines in FIG. 10). In the case where blue papers are set in the paper feed cassette 105C, the paper position display unit 18 displays the cassette information and the like by characters, and colors the position of the paper feed cassette 105C in blue (crosshatched in FIG. 10). The paper position display unit 18 may also color the displayed characters in the color of paper of the corresponding paper information.

Also, as a method for highlighting the paper to be used at the time of printing, the paper position display unit 18 flashes the corresponding position (the manual paper feed unit 104 or the paper feed cassette unit 105 in the graphic image of the image processing apparatus 300 that has been colored as described above), or surrounds the cassette information with a rectangular area. The paper position display unit 18 may also take other highlighting methods than the above method, such as making the displayed characters bold or showing an inverted display.

In this embodiment, A4 vertical-size green papers are set as insertion papers A in the manual paper feed unit 104 (Manual), and A4 vertical-size white papers are set as insertion papers B in the paper feed cassette 105A (First Cassette), as shown in FIG. 10. Also, A4 horizontal-size white papers are set as insertion papers C in the paper feed cassette 105C (Second Cassette), and A4 vertical-size blue papers are set as insertion papers D in the paper feed cassette 105C (Third Cassette). Also, A3 horizontal-size white papers are set as insertion papers E in the paper feed cassette 105D (Fourth Cassette). The paper position display unit 18 highlights “Manual”, “First Cassette” (to be used as default papers) and “Third Cassette” in which papers to be used at the time of printing are set.

As the paper information, cassette information and storage position information displayed by the paper position display unit 18, the information acquired by the paper state acquiring unit 11 is displayed as described above.

Meanwhile, in the case where the paper feed setting is automatic setting as shown in FIG. 11 (for example, setting to supply papers automatically from the manual insertion tray when no papers are left in the cassette), the paper position display unit 18 displays “Automatic” together with the graphic image of the image processing apparatus 300.

Back to the main menu screen of FIG. 6, as the “Real Preview” button is pressed by the user, the print preview unit 19 displays the insertion state in the original or the change state of print paper in a page turning format (step S111). FIG. 11 shows a screen image of “Real Preview”. The print preview unit 19 displays the front and back pages of the original for which the paper setting operation has been completed as described above, and as the “Back” or “Forward” button is pressed, the print preview unit 19 turns pages of the displayed original back or forward as if it were actually turning the pages. Moreover, when the “Automatic Turn” button is pressed, the print preview unit 19 shows a display so that pages are automatically turned at predetermined time intervals.

Each step of the processing in the above print setting apparatus 1 is realized by causing the CPU 801 to execute a print setting program stored in the memory 802.

In this embodiment, since there is no need to switch the display of the print setting screen and the document preparation application, the user can intuitively make setting for the paper while grasping the content of the original and visually confirming the setting. For feedback of the setting result, a list is constantly displayed with the thumbnail of the original in accordance with the reflection of the print state in the printed matter display unit 13 by the state reflecting unit 17. Therefore, even when making setting for plural papers at the same time, the user can visually confirm the order of the respective papers.

Also, the paper position display unit 18 enables the user to grasp the type of paper and the position of the paper feed cassettes (105A to 105D) and the manual paper feed unit 104 simply by viewing the screen. Therefore, the user can grasp the state more intuitively. Also, in the case where the paper feed setting is automatic, the paper position display unit 18 displays the characters “Automatic” on the graphic image of the image processing apparatus 300. Therefore, the user who uses this apparatus for the first time can feel at ease in using the apparatus without being at a loss.

Moreover, since the print preview unit 19 displays the original in the page tuning format, the user can securely grasp the setting content, feeling as if the user had actually printed out and were looking at the original at hand.

In this embodiment, the monitor 200a and the input device 200b in the personal computer 200 are used as the input and output device of the print setting apparatus 1. However, the interface screen 101 in the image processing apparatus 300 may be used as the input and output device. Also, in this embodiment, an input from the mouse of the input device 200b is described as an example, but it may be an input from the keyboard of the input device 200b.

In this embodiment, the combination of the personal computer 200 and the image processing apparatus 300 is described as an example, but the same technique also applies to a combination of another personal computer and another image processing apparatus (for example, a combination of the personal computer 20n and the image processing apparatus 30n in FIG. 1, a combination of the personal computer 200 and the image processing apparatus 30n, and so on).

In this embodiment, the case where the functions to carry out the invention have been recorded in advance in the apparatus is described, but it is not limited to this. The similar functions may be downloaded to the apparatus from a network, or the similar functions stored in a recording medium may be installed into the apparatus. As a recording medium, any form of recording medium that can store a program and that can be read by the apparatus, such as a CD-ROM, maybe employed. Also, the functions that can be provided by being thus installed or downloaded in advance may be realized in cooperation with the OS (operating system) and the like in the apparatus.

The particular embodiment of the invention has been described in detail. However, it is obvious to those skilled in the art that various changes and modifications can be made without departing from the spirit and scope of the invention.

As described above in detail, according to the invention, when making setting for an insertion paper, the user can make the setting while intuitively grasping the state of the insertion paper.

What is claimed is:

1. A print setting apparatus that carries out print setting for an image processing apparatus, the print setting apparatus comprising:
a paper display unit configured to display predetermined paper information related to a paper that can be used in the image processing apparatus, as a list;
a printed matter display unit configured to display a printed matter, which is a print target in the image processing apparatus, as a page list;
a selected paper information acquiring unit configured to acquire selected paper information showing which paper information is selected, of the paper information displayed as a list by the paper display unit;
an insertion position information acquiring unit configured to acquire insertion position information showing which page position a paper should be inserted to, in the page list displayed by the printed matter display unit; and
an insertion state reflecting unit configured to reflect the selected paper information acquired by the selected paper information acquiring unit, in the page list displayed by the printed matter display unit, in a form that the selected paper information is inserted in the insertion position information acquired by the insertion position information acquiring unit.

2. The print setting apparatus according to claim 1, wherein the insertion state reflecting unit reflects the selected paper information that has been inserted, in the page list displayed by the printed matter display unit, in a form that the selected paper information is not included in page numbers of the printed matter.

3. The print setting apparatus according to claim 1, comprising:
a page-to-be-changed information acquiring unit configured to acquire page-to-be-changed information indicating print paper of which page should be changed, of the pages displayed as the list by the printed matter display unit; and
a change state reflecting unit configured to reflect the print paper of the page-to-be-changed information acquired by the page-to-be-changed information acquiring unit, in the page list displayed by the printed matter display unit as the selected paper information acquired by the selected paper information acquiring unit.

4. The print setting apparatus according to claim 1, comprising a paper position display unit configured to display the predetermined paper information together with storage position information indicating a storage position of a paper stored in the image processing apparatus, by at least one of color and character.

5. The print setting apparatus according to claim 4, wherein the paper position display unit displays at least one of the storage position information and the predetermined paper information in association with an image of the image processing apparatus.

6. The print setting apparatus according to claim 4, wherein the paper position display unit highlights at least one of the predetermined paper information and the storage position information, of a paper to be used at the time of printing the printed matter.

7. The print setting apparatus according to claim 4, wherein when paper feed setting in the image processing apparatus is automatic setting, the paper position display unit displays information indicating that the setting is the automatic setting.

8. The print setting apparatus according to claim 1, comprising a paper state information acquiring unit configured to acquire information about at least one of type, paper quality, the number of sheets, and print state of a paper stored in the image processing apparatus,
wherein the predetermined paper information is based on the information acquired by the paper state information acquiring unit.

9. The print setting apparatus according to claim 1, further comprising a print preview unit configured to display a state of the printed matter in a page turning format.

10. A print setting program that causes a computer to execute print setting for an image processing apparatus, the program causing the computer to execute the steps of:
displaying predetermined paper information related to a paper that can be used in the image processing apparatus, as a list;
displaying a printed matter, which is a print target in the image processing apparatus, as a page list;
acquiring selected paper information showing which paper information is selected, of the paper information displayed as a list in the step of displaying paper information;
acquiring insertion position information showing which page position a paper should be inserted to, in the page list displayed in the step of displaying a printed matter; and
reflecting the selected paper information acquired in the step of acquiring selected paper information, in the page list displayed in the step of displaying a printed patter, in a form that the selected paper information is inserted in the insertion position information acquired in the step of acquiring insertion position information.

11. The print setting program according to claim 10, wherein in the step of reflecting, the selected paper information that has been inserted is reflected in the page list displayed in the step of displaying a printed matter, in a form that the selected paper information is not included in page numbers of the printed matter.

12. The print setting program according to claim 10, wherein the program causes the computer to execute the steps of:
acquiring page-to-be-changed information indicating print paper of which page should be changed, of the pages displayed as the list in the step of displaying a printed matter; and
reflecting the print paper of the page-to-be-changed information acquired in the step of acquiring page-to-be-changed information, in the page list displayed in the step of displaying a printed matter as the selected paper information acquired in the step of acquiring selected paper information.

13. The print setting program according to claim 10, wherein the program causes the computer to execute the step of displaying the predetermined paper information together with storage position information indicating a storage position of a paper stored in the image processing apparatus, by at least one of color and character.

14. The print setting program according to claim 13, wherein in the step of displaying paper position, at least one of the storage position information and the predetermined paper information is displayed in association with an image of the image processing apparatus.

15. The print setting program according to claim 13, wherein in the step of displaying paper position, at least one of the predetermined paper information and the storage position information, of a paper to be used at the time of printing the printed matter, is highlighted.

16. A print setting method for executing print setting for an image processing apparatus, the method comprising the steps of:
displaying predetermined paper information related to a paper that can be used in the image processing apparatus, as a list;
displaying a printed matter, which is a print target in the image processing apparatus, as a page list;
acquiring selected paper information showing which paper information is selected, of the paper information displayed as a list in the step of displaying paper information;
acquiring insertion position information showing which page position a paper should be inserted to, in the page list displayed in the step of displaying a printed matter; and
reflecting the selected paper information acquired in the step of acquiring selected paper information, in the page list displayed in the step of displaying a printed patter, in a form that the selected paper information is inserted in the insertion position information acquired in the step of acquiring insertion position information.

17. The print setting method according to claim 16, wherein in the step of reflecting, the selected paper information that has been inserted is reflected in the page list displayed in the step of displaying a printed matter, in a form that the selected paper information is not included in page numbers of the printed matter.

18. The print setting method according to claim 16, wherein the steps of:
acquiring page-to-be-changed information indicating print paper of which page should be changed, of the pages displayed as the list in the step of displaying a printed matter; and
reflecting the print paper of the page-to-be-changed information acquired in the step of acquiring page-to-be-changed information, in the page list displayed in the step of displaying a printed matter as the selected paper information acquired in the step of acquiring selected paper information,
are executed.

19. The print setting method according to claim 16, wherein the step of displaying the predetermined paper information together with storage position information indicating a storage position of a paper stored in the image processing apparatus, by at least one of color and character, is executed.

20. The print setting method according to claim 19, wherein in the step of displaying paper position, at least one of the storage position information and the predetermined paper information is displayed in association with an image of the image processing apparatus.
